(19) United States
(12) Patent Application Publication
(10) Pub. No.: US 2018/0099765 A1
(43) Pub. Date: Apr. 12, 2018

(54) Method and System for Moving Vehicles

(71) Applicant: Justin Lee, McDonough, GA (US)

(72) Inventor: Justin Lee, McDonough, GA (US)

(21) Appl. No.: 15/291,066

(22) Filed: Oct. 12, 2016

(51) Int. Cl. B64G 1/40; B64F 1/04; B64C 39/00; B64F 1/22; B64F 5/40

(52) U.S. Cl. CPC B64G 1/405; B64F 1/04; B64F 5/40; B64F 1/222; B64C 39/00

(57) ABSTRACT

Disclosed herein are method and system for moving vehicles, the system comprising: at least one power distribution station (PDS), each power distribution station comprising: a power source; and at least one transmitter array comprising a plurality of transmitter, each transmitter array configured to wirelessly transmit power to a receiver; and at least one flight-capable vehicle, each vehicle comprising: a craft configured to carry a payload; at least one receiver configured to receive and utilize the power transmitted from the transmitter array to power the vehicle; and a lifting array comprising a plurality of ion-producing propulsion means, the lifting array coupled to the vehicle and configured to lift the vehicle a predetermined altitude and distance using power from the receiver. Also disclosed herein are aerial rapid transit system for moving vehicles.

### CROSS REFERENCE TO RELATED APPLICATIONS

This claims the benefit of priority to U.S. Provisional Patent Application Ser. No. 62/239,183, filed Oct. 8, 2015, which is hereby incorporated herein by reference in its entirety.

### FIELD OF INVENTION

The present invention relates to methods and systems for moving vehicles, and more specifically, wirelessly powered vehicles.

### BACKGROUND OF THE INVENTION

A faster more convenient mode of transit is more desirable now than ever. Aerial vehicles may be used for a plurality of applications. Such applications can include commercial applications such as transporting cargo and passengers. However, current aerial vehicle and system configurations have limitations with respect to powering and propulsion means, transport efficiency, and scalability.

Accordingly, there remains a need for new aerial vehicles and systems which utilize alternative modes of powering and propulsion, and are capable of efficiently and effectively being deployed in large numbers. This need and other needs are satisfied by the various aspects of the present disclosure.

### SUMMARY OF THE INVENTION

In accordance with the purposes of the invention, as embodied and broadly described herein, the invention, in one aspect, relates to a method and system for moving vehicles. In a further aspect, the invention relates to a system for moving vehicles, the system comprising: at least one power distribution station (PDS), each power distribution station comprising: a power source; and at least one transmitter array comprising a plurality of transmitter, each transmitter array configured to wirelessly transmit power to a receiver; and at least one flight-capable vehicle, each vehicle comprising: a craft configured to carry a payload; at least one receiver configured to receive and utilize the power transmitted from the transmitter array to power the vehicle; and a lifting array comprising a plurality of ion-producing propulsion means, the lifting array coupled to the vehicle and configured to lift the vehicle a predetermined altitude and distance using power from the receiver.

In another exemplary aspect, the invention relates to an aerial mass transit system for moving vehicles, the system comprising: at least one power distribution station (PDS), each power distribution station comprising: a power source; at least one transmitter array comprising a plurality of transmitters, each transmitter array configured to wirelessly transmit power to a receiver; and a first flight-capable vehicle, each first vehicle comprising: a craft configured to carry a payload; at least one receiver configured to receive and utilize the power transmitted from the transmitter array to power the vehicle; and a lifting array comprising a plurality of ion-producing propulsion means, the lifting array coupled to the vehicle and configured to lift the vehicle to a predetermined altitude and distance using power from the receiver; a second flight-capable vehicle, each second vehicle comprising: a craft configured to carry a payload; at least one receiver configured to receive and utilize the power transmitted from the transmitter array to power the vehicle; a lifting array comprising a plurality of ion-producing propulsion means, the lifting array coupled to the vehicle and configured to lift the vehicle to a predetermined altitude and distance using power from the receiver; at least one energy storage unit configured to store a required energy amount; and a power management unit, the power management unit comprising at least one transmitter relay comprising a plurality of transmitters, each transmitter relay configured to wirelessly retransmit power to a receiver of another vehicle; and at least one vehicle storage facility (VSF) configured to house one or more vehicles.

In further aspects, the invention also relates to methods for using the disclosed vehicles and systems.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several aspects of the invention and together with the description, serve to explain the principles of the invention. Furthermore, the drawings may contain text or captions that may explain certain embodiments of the present disclosure. This text is included for illustrative, non-limiting, explanatory purposes of certain embodiments detailed in the present disclosure.

FIGS. 1A and 1B shows depictions of a system for moving vehicles in accordance with an exemplary embodiment of the present disclosure.

FIG. 2 shows a depiction of a power distribution station (PDS) in accordance with an exemplary embodiment of the present disclosure.

FIG. 3 shows a depiction of a power distribution station (PDS) in accordance with an exemplary embodiment of the present disclosure.

FIG. 4 shows a depiction of a power distribution station (PDS) in accordance with an exemplary embodiment of the present disclosure.

FIG. 5 shows a depiction of a power distribution station (PDS) in accordance with an exemplary embodiment of the present disclosure.

FIG. 6 shows a depiction of a flight-capable aerial vehicle in accordance with an exemplary embodiment of the present disclosure.

FIG. 7 shows a depiction of a flight-capable aerial vehicle in accordance with an exemplary embodiment of the present disclosure.

FIG. 8 shows a depiction of a flight-capable aerial vehicle in accordance with an exemplary embodiment of the present disclosure.

FIG. 9 shows a depiction of a flight-capable aerial vehicle in accordance with an exemplary embodiment of the present disclosure.

FIG. 10 shows a depiction of a flight-capable aerial vehicle in accordance with an exemplary embodiment of the present disclosure.

FIGS. 11A and 11B show depictions of a system for moving vehicles configured as an aerial mass transit system (ATMS) in accordance with an exemplary embodiment of the present disclosure.

FIGS. 12A-12C shows depictions of a power distribution station (PDS) used in the ATMS configuration in accordance with an exemplary embodiment of the present disclosure.

FIGS. 13A-13B shows depictions of a flight-capable aerial vehicle in accordance with an exemplary embodiment of the present disclosure.

FIGS. 14A-13D shows depictions of a flight-capable aerial vehicle in accordance with an exemplary embodiment of the present disclosure.

FIGS. 15A-15F shows depictions of a vehicle storage facility (VSF) used in the ATMS configuration in accordance with an exemplary embodiment of the present disclosure.

FIG. 16 shows a flow chart depicting a method for operating the system for moving vehicles in accordance with an exemplary embodiment of the present disclosure.

FIG. 17 shows a block diagram of a vehicle controller consistent with exemplary embodiments of the present disclosure.

### DETAILED DESCRIPTION OF THE INVENTION

The present invention can be understood more readily by reference to the following detailed description of the invention and the Examples included therein.

Before the present articles, systems, devices, and/or methods are disclosed and described, it is to be understood that they are not limited to specific manufacturing methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

All publications mentioned herein are incorporated herein by reference to disclose and describe the methods and/or materials in connection with which the publications are cited.

### A. Definitions

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a receiver” includes two or more receivers.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

Disclosed are the components to be used to manufacture the disclosed devices and articles of the invention as well as the materials themselves to be used within the methods disclosed herein. These and other materials are disclosed herein, and it is understood that when combinations, subsets, interactions, groups, etc. of these materials are disclosed that while specific reference of each various individual and collective combinations and permutation of these materials cannot be explicitly disclosed, each is specifically contemplated and described herein. For example, if a particular material is disclosed and discussed and a number of modifications that can be made to the materials are discussed, specifically contemplated is each and every combination and permutation of the material and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the articles and devices of the invention. Thus, if there are a variety of additional steps that can be performed it is understood that each of these additional steps can be performed with any specific aspect or combination of aspects of the methods of the invention.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

It is understood that the devices and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. System for Moving Vehicles

As briefly described above, the present disclosure relates, in various aspects, to a system for moving vehicles, such as wirelessly powered vehicles. In one aspect, the present disclosure provides a system for moving vehicles, the system comprising: at least one power distribution station (PDS), each power distribution station comprising: a power source; and at least one transmitter array comprising a plurality of transmitter, each transmitter array configured to wirelessly transmit power to a receiver; and at least one flight-capable vehicle, each vehicle comprising: a craft configured to carry a payload; at least one receiver configured to receive and utilize the power transmitted from the transmitter array to power the vehicle; and a lifting array comprising a plurality of ion-producing propulsion means, the lifting array coupled to the vehicle and configured to lift the vehicle a predetermined altitude and distance using power from the receiver.

In various aspects, the power distribution station can further comprise at least one energy storage unit. In further aspects, the energy storage unit can comprise an electrical device configured to store a total required potential or energy for at least one complete flight cycle or lift cycle of a vehicle. In still further aspects, the energy storage unit can be configured to release the potential or energy in a controlled discharge through the duration of a flight cycle or lift cycle of a vehicle. In yet further aspects, the energy storage unit can comprise a battery, a capacitor, or a combination thereof. In some aspects, the energy storage unit can comprise a plurality of energy storage devices. In still further aspects, the plurality of energy storage units can comprise a series of duplicate electrical devices acting simultaneously.

In further aspects, the power source can comprise conventional power, alternative fuel power, renewable power, power generated on-site, power fed from off-site, or any combination thereof. In still further aspect, the power of the power source can be derived from coal, natural gas, nuclear, wind, solar, geothermal, fuel cell, cellulose, ethanol, or any combination thereof.

In further aspects, the transmitters of the transmitter array can comprise an antenna, or a mount, or any combination thereof. In still further aspects, the antenna can be configured to produce electromagnetic waves from an applied current, such as from the power source or energy storage unit. In yet further aspects, the mount can comprise a protective housing that supports the antenna on an articulated base. In even further aspects, the mount can comprise a positional mechanism configured to orient the antenna in a direction. In still further aspects, the positional mechanism can comprise hydraulic systems, stepper motors, rack and pinion systems, or any combination thereof.

In various aspects, the transmitters are configured to rotate or pivot to remain continuously pointed at a vehicle during a flight cycle or lift cycle. In further aspects, the transmitters can be positioned centrally or at predetermined distance intervals from the dispersed throughout the base station to provide different lines of sight to the vehicle, or a combination thereof. In some aspects, the transmitters can be positioned in locations to continually provide unobstructed line of sight to a vehicle. In other aspects, the transmitters can operate collectively or in a sequence as the vehicle follows a flight course or flight path.

In various aspects, the system can comprise a plurality of transmitter arrays. In further aspects, the system can comprise a sufficient number of transmitter arrays to power the vehicle for a predetermined distance and altitude. By way of non-limiting example, the system can comprise a first transmitter array that can be positioned beneath a launch platform to power the vehicle during an initial portion of flight, and second transmitter array can be located away from the first transmitter array and may power the vehicle once the launch platform is cleared, and a third transmitter array can be located in a different location and may power the vehicle as its trajectory moves it beyond the view or range of the first and second transmitter arrays.

In various aspects, the power distribution station can comprise devices, components, equipment, processing logic and/or circuitry for monitoring, tracking, communication and controlling operation of the PDSs. In further aspects, the system can comprise a power distribution station controller configured to monitor and control operation of the power distribution station. In still further aspects, the PDS controller can comprises a monitoring module, or a communication module, or a tracking module, or any combination thereof. In even further aspects, the PDS controller can be configured to track and report the position of the vehicle (for example, using radar, LIDAR, or the like), to convert location data into positional data for the transmitter array, to communicate with any passengers of the vehicle (e.g. radio), to control flight cycle management, or monitor vehicle status, or any combination thereof.

In further aspects, the PDS controller can be configured to determine if any vehicles are within the range of a transmitter array, and wherein when a vehicle is within range, transfer power from the power source to the antenna to wirelessly transmit to the vehicle. In still further aspects, the PDS controller can be configured to utilize positional data to direct the positional mechanisms in the mount to orient the antenna toward the designated vehicle. In still further aspects, when multiple transmitter arrays are utilized, the transmitter arrays can be connected to the PDS controller to enable adaptive switching between transmitter arrays as a vehicle moves from one array to the next. In some aspects, the PDS controller switches between arrays in accordance with the feedback signal received from the vehicle. The feedback signal can comprise authentication information and/or vehicle status information.

In further aspects, the power distribution station can comprise at least one platform. In still further aspects, the platform can comprise a structure configured to provide an operating surface for at least one component or equipment of the system. In some aspects, at least one component of the power distribution station is located on the platform. In other aspects, at least one transmitter array is located on the platform. In further aspects, the platform can comprise an elevated platform having a predetermined height. To this end, the height can be sufficient to position the platform above obstructions, such as, for example, tall vegetation or buildings, or the like.

In some aspects, the system can comprise a plurality of PDSs. In further aspects, the plurality of PDSs can be established at regular intervals about the equator, including, but not limited to seaborne variants designed as self-sustaining floating stations. In further aspects, the system can comprise a complementary receiving station located over each equatorial PDS in a geosynchronous Earth orbit (GEO) to provide a stable destination for vehicle shuttling from the planet and a permanent platform for advanced off-planet research. Without wishing to be bound by a particular theory, this system configuration may provide cost-effective, reliable transit to and from space.

In various aspects, the system comprises at least one flight-capable vehicle. In further aspects, the vehicle can comprise: a craft configured to carry a payload; at least one receiver configured to receive and utilize the power transmitted from the transmitter array to power the vehicle; and a lifting array comprising a plurality of ion-producing propulsion means, the lifting array coupled to the vehicle and configured to lift the vehicle to a predetermined altitude and distance using power from the receiver.

In further aspects, the craft can comprise a housing, vessel, fuselage, or any combination thereof. In still further aspects, the craft can comprise any flightworthy construction capable of carrying a payload. In some aspects, the vehicle can comprise a plurality of receivers. In other aspects, the vehicle can comprise a receiver array comprising a plurality of receivers. In further aspects, the receiver can comprise single collection point or a group of collection points positioned about the vehicle. In still further aspects, the receiver can be configured to receive and utilize the power transmitted from the transmitter array to power the vehicle.

In further aspects, the vehicle comprises at least one lifting array comprising a plurality of ion-producing propulsion means. In still further aspects, the lifting array can be coupled to the vehicle and configured to lift the vehicle to a predetermined altitude and distance using power from the receiver. In yet further aspects, the lifting array can be configured to produce lift using electrohydrodynamic phenomena associated with high voltages applied to fluids. In still further aspects, the lifting array can comprise an ionizing wire, a dielectric fluid, or an ion collector, or any combination thereof. In even further aspects, the ionizing wire can comprise an electrode that when energized in the kilovolt range, is configured to ionize surrounding dielectric molecules. In yet further aspects, the dielectric fluid comprises a volume of nonconductive free flowing material of which molecules can be freely ionized, such as, and without limitation, air, and the like. In still further aspects, the ion collector can comprise an electrode that attracts ions produced in the dielectric fluid.

In various aspects, when an electric potential in the kilovolt range is applied to the ionizing wire, molecules in the dielectric fluid are excited releasing ions. The released ions possess the same charge as the ionizing wire and are therefore repelled from said wire toward the ion collector. The ion collector has the opposite polarity of the ionizing wire and therefore attracts the ions produced in the dielectric field. The ions impart their charge onto the ion collector completing the circuit of the ion-producing device. The uniform movement of ions produces lift along the axis of the device. By varying the voltage applied to the device, varying levels of lift may be generated. The vehicle controller and control software can dynamically supply differing voltages to the various ion-producing devices to orient the vehicle.

To this end, the vehicle can comprise devices, components, equipment, processing logic and/or circuitry for monitoring, tracking, communication and controlling operation of the vehicle. In further aspects, the system can comprise an on-board vehicle controller configured to monitor and control operation of the vehicle. In still further aspects, the vehicle controller can comprise a monitoring module, or a communication module, or a tracking module, or any combination thereof. In even further aspects, the vehicle controller can be configured to track and report the position of the vehicle (for example, using radar, LIDAR, or the like), to provide positional data for the transmitter array, to communicate with central control or remote operator (e.g. radio), to control flight cycle management, or monitor and report vehicle status, or any combination thereof. In still further aspects, the vehicle controller can be configured to control transfer power from the receiver to the components of the lifting array, to maintain a course during a flight cycle (e.g. auto-piloting software, flight course data, and navigation logic), and to transmit and receive vehicle information.

In some aspects, the vehicle controller can comprise destination access and or authorization software. For example, the controller can comprise a protocol that determines if a customer has clearance to operate or send a vehicle to a selected destination. In further aspects, the software can be configured to prevent unauthorized use of vehicle, access to private property, government facilities, and other restricted areas.

In other aspects, the vehicle controller can comprise monitoring and emergency declaration systems. In further aspects, the vehicle can comprise status monitoring equipment that allow occupants to declare a medical emergency. In still further aspects, the vehicle can also detect acts of vandalism which may divert the vehicle to the nearest Emergency Station, hospital or other appropriate emergency/law enforcement facility.

In some aspects, the vehicle can further comprise at least one energy storage unit. In further aspects, the energy storage unit can comprise an electrical device configured to store a total required potential or energy for at least one complete flight cycle or lift cycle of a vehicle. In still further aspects, the energy storage unit can be configured to release the potential or energy in a controlled discharge through the duration of a flight cycle or lift cycle of a vehicle. In yet further aspects, the energy storage unit can comprise a battery, a capacitor, or a combination thereof. In some aspects, the energy storage unit can comprise a plurality of energy storage devices. In still further aspects, the plurality of energy storage units can comprise a series of duplicate electrical devices acting simultaneously. In even further aspects, the energy storage unit can be configured to power the circuitry of essential components of the vehicle to allow the vehicle to make a controlled emergency descent in the event of a power outage.

In various aspects, the vehicle can comprise multiple configurations. For example, the vehicle can be configured as a payload vehicle or a relay vehicle. In some aspects, the payload vehicle is configured to carry passengers and or cargo, or any combination thereof. In further aspects, the payload vehicle can be configured for passenger interaction, such as with user interfaces and controls. In still further aspects, the payload vehicle can comprise at least one of: doors, windows, interior lights, seating, information displays, cargo tie-down points, and climate control, and the like.

In other aspects, the vehicle can be configured as a relay vehicle. In further aspects, the relay vehicle can be configured to extend the range of payload vehicles by collecting and storing electromagnetic energy from PDSs and retransmitting the stored energy to other payload vehicles and/or relay vehicles, such as, for example, in situations where vehicles would otherwise be out of line of sight of a PDS or transmitters.

In further aspects, the vehicle can comprise a power management unit. In still further aspect, the power management unit can comprise at least one transmitter array comprising a plurality of transmitter, each transmitter array configured to wirelessly transmit power to a receiver. To this end, a relay vehicle comprising a power management unit can act as a mobile aerial version of a power distribution station, complete with tracking, control, and communication abilities plus a transmitter array that all function similarly to their ground-based variants. In yet further aspect, the power management unit can comprise equipment to move power from the receiver to the power management unit for distribution to other vehicles while maintaining power to the relay vehicle's components.

In various aspects, the system can comprise at least one vehicle storage facility (VSF) configured to house one or more vehicles. In further aspects, the VSF can comprise automated, climate-controlled hangars with moving platforms that taxi vehicles into and out of a warehouse containing holding bays (bay). In some aspects, once a vehicle is not needed, the vehicle can navigate to a VSF landing/loading platform. In further aspects, the vehicle may be secured to the platform and moved into the warehouse where a conveyance system moves it to an available bay. In still further aspects, the vehicle may be left in the bay while the disengaged platform moves to: collect a requested vehicle from a different bay, receive another arriving vehicle, or wait in a platform holding silo in the warehouse. In yet further aspects, the VSF can comprise a landing and/or take-off area with several platform spaces to facilitate multiple vehicles arriving and/or departing simultaneously.

In various aspects, the VSF can be configured for public, private, or commercial use, or any combination thereof. In some aspects, a public VSF may be configured to handle unoccupied arriving vehicles and functioning as described herein with an on-demand schedule. In further aspects public VSFs can serve as storage hubs during off-peak hours.

In other aspects, commercial VSFs can function like public VSFs, but include additional features. For example, commercial VSFs can comprise added pedestrian amenities (walkways, seating areas, loading docks, etc.) to accommodate occupied vehicles arriving and departing from the VSF. In further aspects commercial VSFs of various capacities can serve as short-term holding sites for vehicles that may be needed again shortly, and may be needed to absorb high demand spikes associated with densely populated locations (retail centers, multi-dwelling structures, industrial/office parks, and the like.

In yet other aspects, private VSFs can functioning as garages. In further aspects, private VSFs can comprise individual bays installed at a customer premises to properly store privately owned vehicles. In some aspects, private VSFs may include the taxi platforms present in public and commercial VSFs.

In further aspects, VSFs can comprise vehicle diagnostic and maintenance equipment. In still further aspects, the equipment can be configured to run and maintain a Preventative Maintenance Cycle (PMC) database. In some aspects, the system can comprise tools and equipment to keep track of vehicle service hours and can mandate a PMC at regular intervals. In further aspects, a PMC can comprise of a vehicle system diagnostic and may either clear a vehicle for further service, or declare a vehicle un-flightworthy and remove it from service pending repair, retrofit, or decommission.

In further aspects, the system can comprise one or more emergency stations. In still further aspects, emergency stations can comprise landing zones established at periodic intervals along major routes providing medical, security and bathroom amenities. Emergency Stations can act similarly to rest stops found along today's major highways.

In some aspects, the AMTS dispatches one or more relay vehicles to establish an electromagnetic link between the nearest PDS and out of range payload vehicles. In further aspects, a relay vehicle shadows a payload vehicle until the payload vehicle moves within range of a PDS. A relay vehicle can begin to shadow a payload vehicle as the payload vehicle moves beyond the range of a PDS.

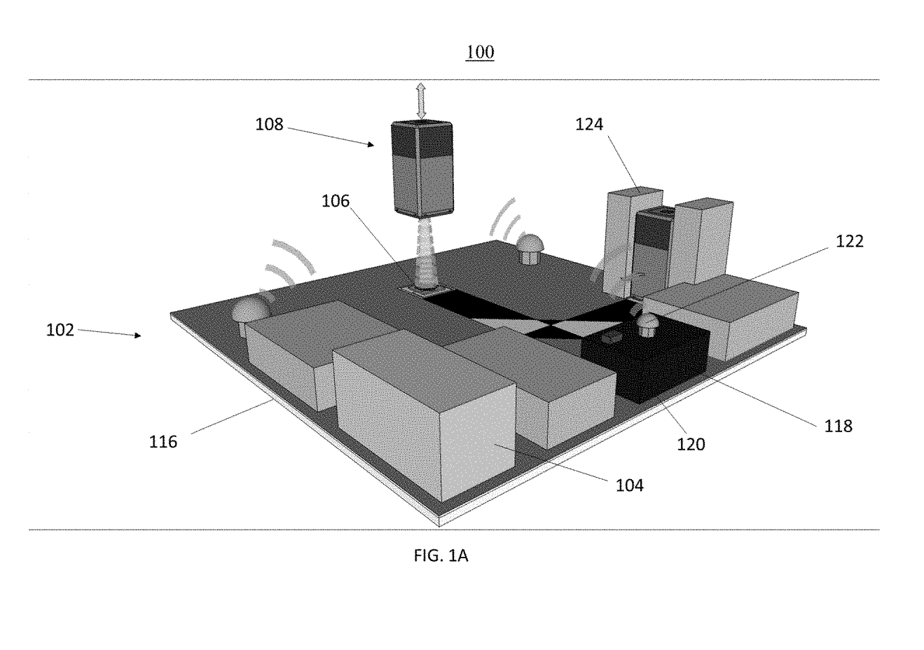

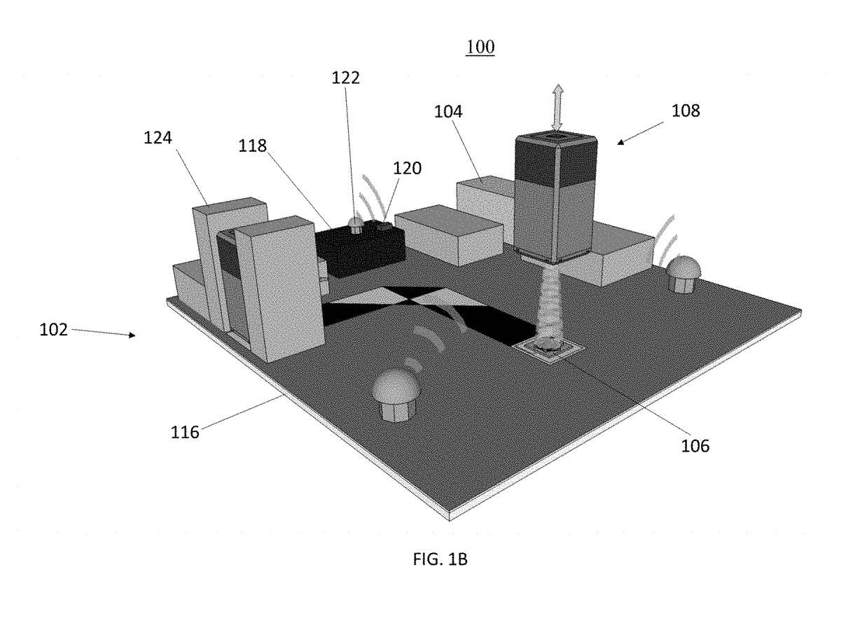

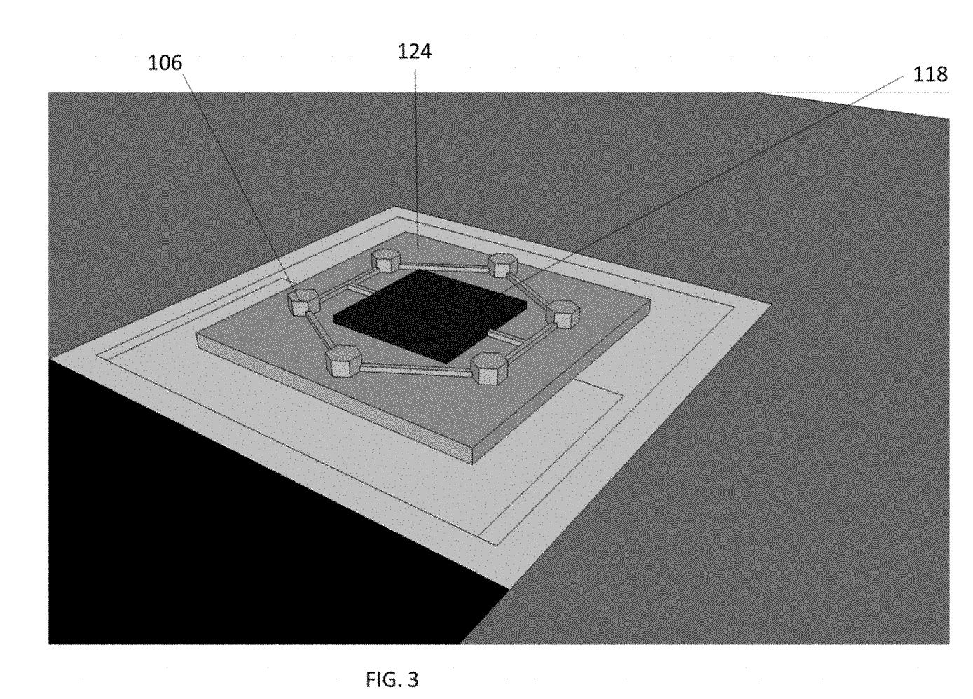

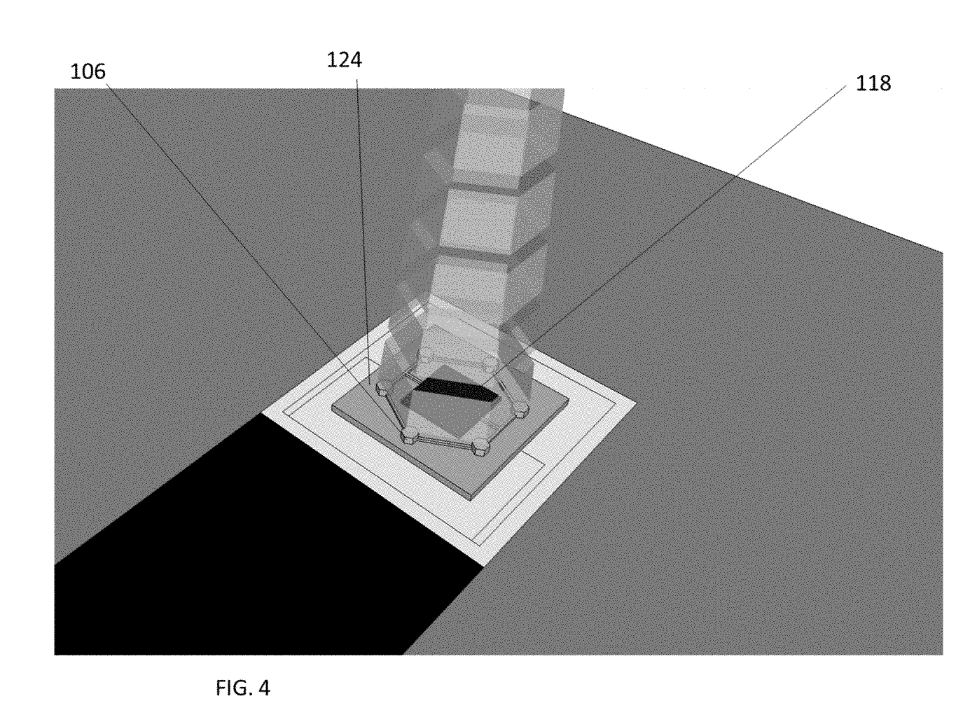

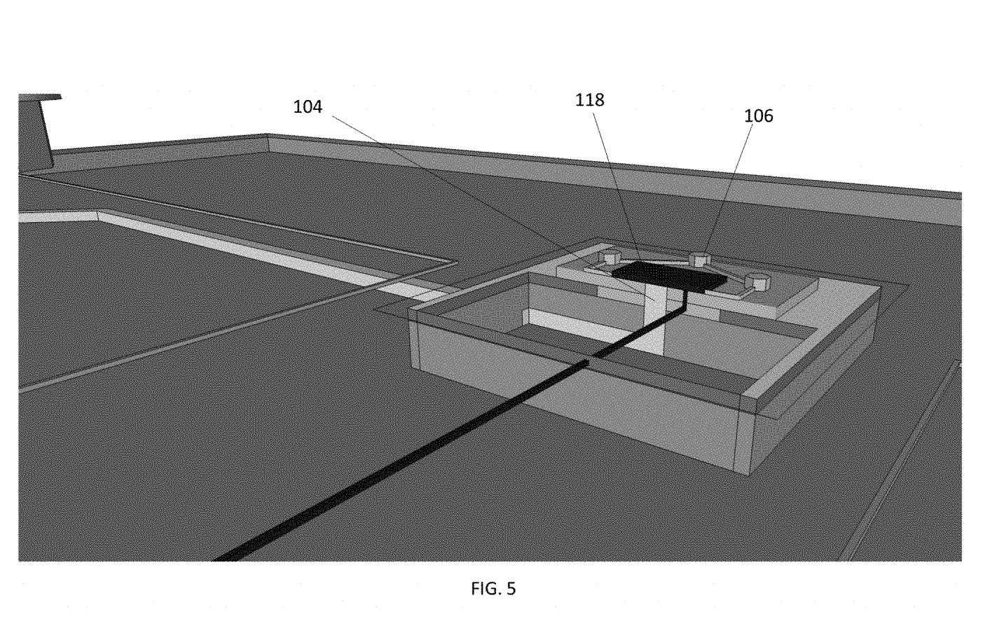

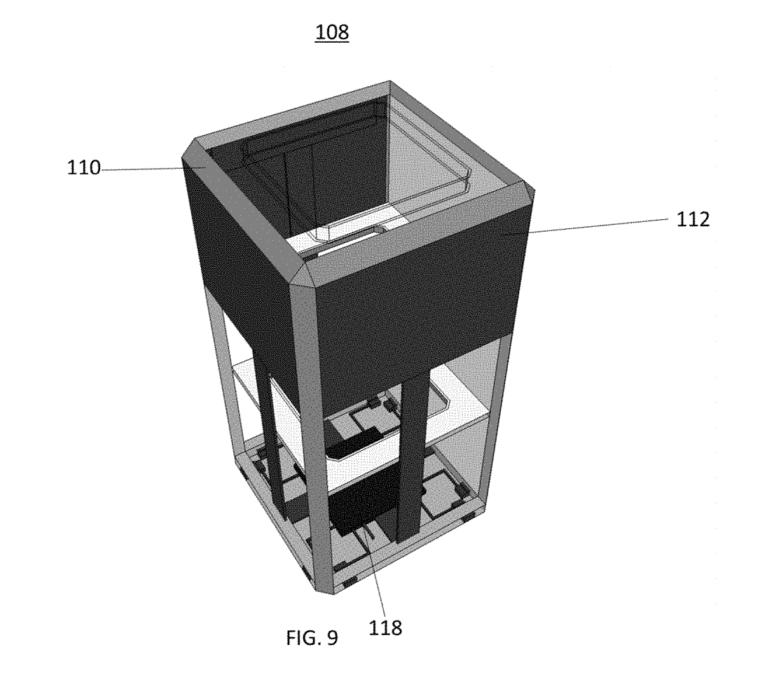

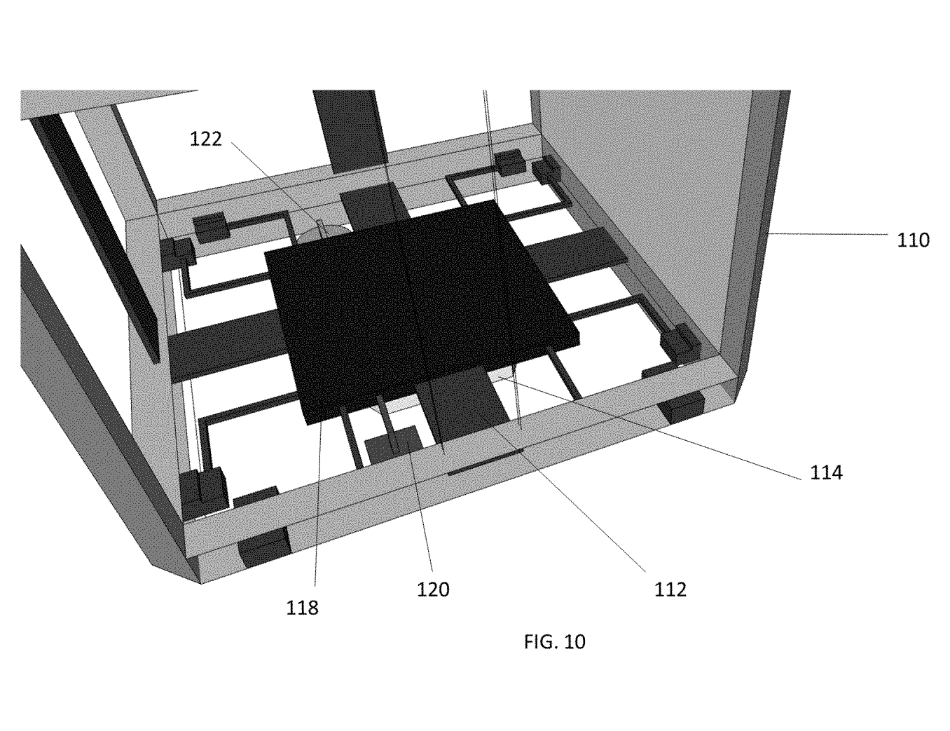

According to various aspects of the invention, the aerial vehicles and systems can comprise multiple configurations. For example, various exemplary embodiments of the inventive aerial vehicles and systems are shown in FIGS. 1-17.

In further aspects, FIGS. 1A and 1B show a system 100 for moving vehicles, the system comprising: a power distribution station (PDS) 102, the power distribution station comprising: a power source 104; a transmitter array 106 comprising a plurality of transmitters, each transmitter array configured to wirelessly transmit power to a receiver; and two flight-capable vehicles 108, each vehicle configured to carry a payload and to receive and utilize the power transmitted from the transmitter array to power the vehicle. As further depicted in FIGS. 1A and 1B, the power distribution station comprises a platform 116, the platform 116 comprises a structure configured to provide an operating surface for the components of the power distribution station. Further, in the present exemplary embodiment, the power distribution station 102 further comprises a power distribution station controller 118, a communication module 120, and a tracking module 122. These control systems are configured to monitor and control operation of the power distribution station. The system further comprises various support structures 124, in the form of a hangar and launch platform.

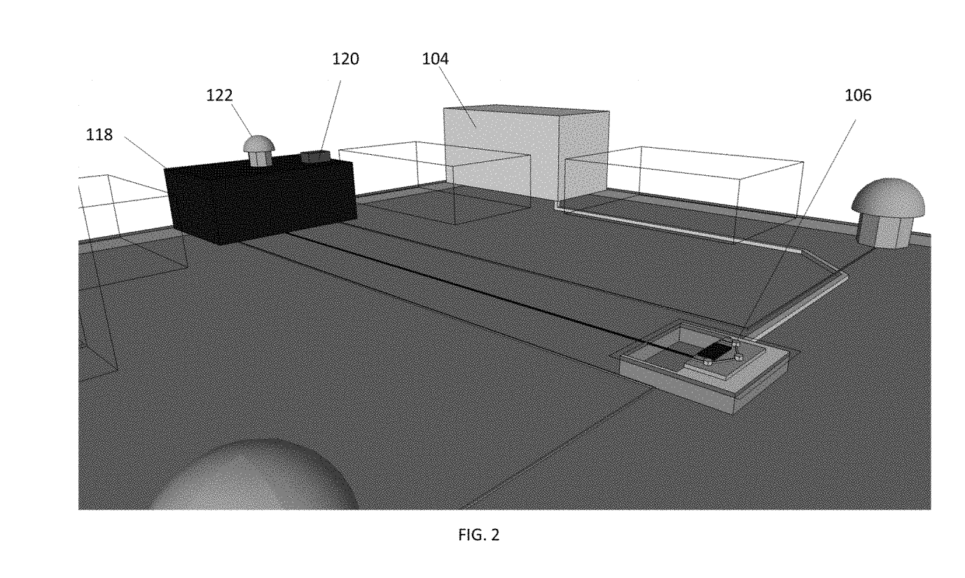

In further aspects, FIGS. 2-5 show various view of an exemplary embodiment of a power distribution station (PDS) 102. In this embodiment, each power distribution station comprises: a power source 104; a transmitter array 106 comprising a plurality of transmitters, the transmitter array being configured to wirelessly transmit power to a receiver; platform 116 comprises a structure configured to provide an operating surface for the components of the power distribution station; a power distribution station controller 118, a communication module 120, a tracking module 122, and a support structure 124 in the form of a launch platform. As shown in FIGS. 2-5, the power source 104 and the PDS controller 118 are coupled to the transmitter array 106 through a cable and/or circuitry. To this end, the PDS controller and related devices are configured to monitor and control operation of the power distribution station. For example, PDS controller 118 can be configured to track and report the location of a vehicle using one or more tracking modules 122, convert location data into positional data for the transmitter array 106 to control flight cycle management; communicate with any occupants of the vehicle using the communication module 120, (e.g. radio), or the like. Using the location data, the PDS controller 118 can be configured to determine if any vehicles are within the range of a transmitter array, and when a vehicle is within range, transfer power from the power source 104 to the transmitter antenna of the transmitter array 106 to wirelessly transmit power to the vehicle.

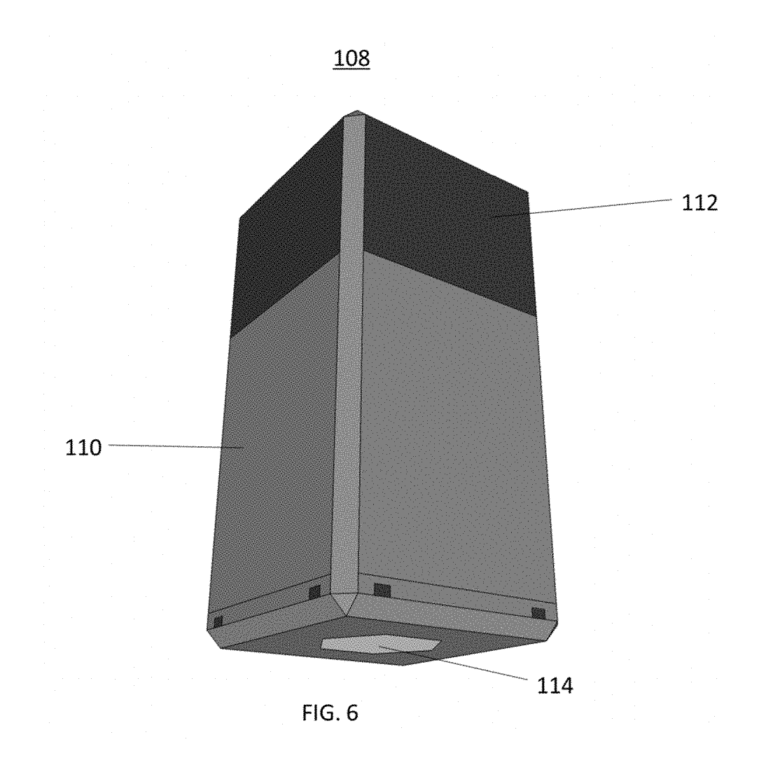

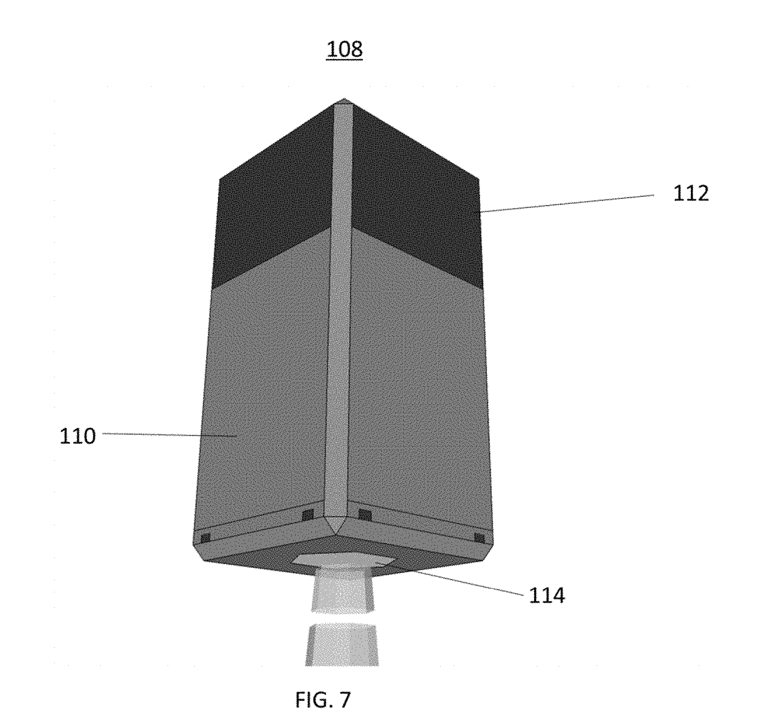

In further aspects, FIGS. 6-10 show various views of an exemplary embodiment of a flight-capable aerial vehicle 108. The vehicle 108 configured to carry a payload and to receive and utilize the power transmitted from the transmitter array to power the vehicle. As further depicted in FIGS. 6-7, the vehicle 108 comprises a craft 110 configured to carry a payload; at least one receiver 114 configured to receive and utilize the power transmitted from the transmitter array to power the vehicle; and a lifting array 112 comprising a plurality of ion-producing propulsion means. The lifting array 112 is coupled to the vehicle and configured to lift the vehicle to a predetermined altitude and distance using power from the receiver. the lifting array is configured to produce lift using electrohydrodynamic phenomena associated with high voltages applied to fluids. In exemplary embodiments, the lifting array further utilizes an ionizing wire, a dielectric fluid, and an ion collector to produce sufficient propulsion or lift to move the vehicle through a flight cycle. The ionizing wire comprises an electrode that when energized in the kilovolt range, is configured to ionize surrounding dielectric molecules, the dielectric fluid comprises a volume of nonconductive free flowing material of which molecules can be freely ionized. (e.g. air), and the ion collector comprises an electrode that attracts ions produced in the dielectric fluid. Without wishing to be bound by a particular theory, when an electric potential in the kilovolt range is applied to the ionizing wire, molecules in the dielectric fluid are excited releasing ions. The released ions possess the same charge as the ionizing wire and are therefore repelled from said wire toward the ion collector. The ion collector has the opposite polarity of the ionizing wire and therefore attracts the ions produced in the dielectric field. The ions impart their charge onto the ion collector completing the circuit of the ion-producing device. The uniform movement of ions produces lift along the axis of the device. By varying the voltage applied to the device, varying levels of lift may be generated.

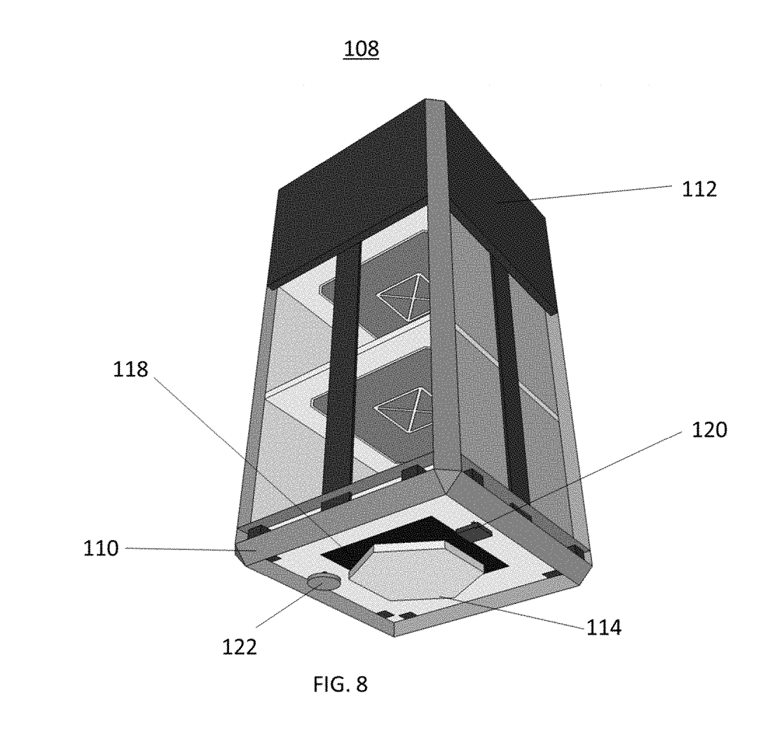

As shown in FIGS. 8-10, the vehicle can further comprise a vehicle controller 126, a vehicle communication module 128, and a vehicle tracking module 130. The vehicle controller 126, a vehicle communication module 128, and a vehicle tracking module 130 can be configured to control transfer power from the receiver 114 to the components of the lifting array 112, to maintain a course during a flight cycle (e.g., by using auto-piloting software, flight course data, navigation logic, and the like), and to communicate and receive information with personnel at a power distribution station or remote location. The vehicle can further comprise control software that dynamically supplies differing voltages to the various ion-producing devices to orient the vehicle. It should be understood that the vehicle may be configured with various propulsion mechanisms, and that lifting array 112 is just one illustrated variation. Other propulsion mechanisms may include, but are not limited to, rockets, jet engines and compressed gas jets. Moreover, in some embodiments, no propulsion may be required at all, as the vehicle can, in some aspects, have characteristics of a glider. In such embodiments, the vehicle may be launched or released from, for example, a carrier vehicle within gliding range of its target. The various properties of the vehicle, as described in various embodiments herein, can provide the vehicle with sufficient flight time to accomplish a flight cycle.

In further aspects, craft 110 can be comprised of, but not limited to, for example, plastics, metals or carbon fiber. Further, craft 110 can be comprised of, but not limited to, for example, a composite or reinforced material (e.g., fiberglass). In various embodiments, craft 110 can have an aerodynamic configuration to facilitate speed and reduced air drag. The receiver 114 can be positioned in various portions of the vehicle. For example, receiver 114 may be fixed, and, in some embodiments, may be conformal (i.e., built into the craft 110). Alternatively, receiver 114 may be deployable. For example, receiver 114 can be configured to deploy out from the craft (e.g., via a spring) on a hinge.

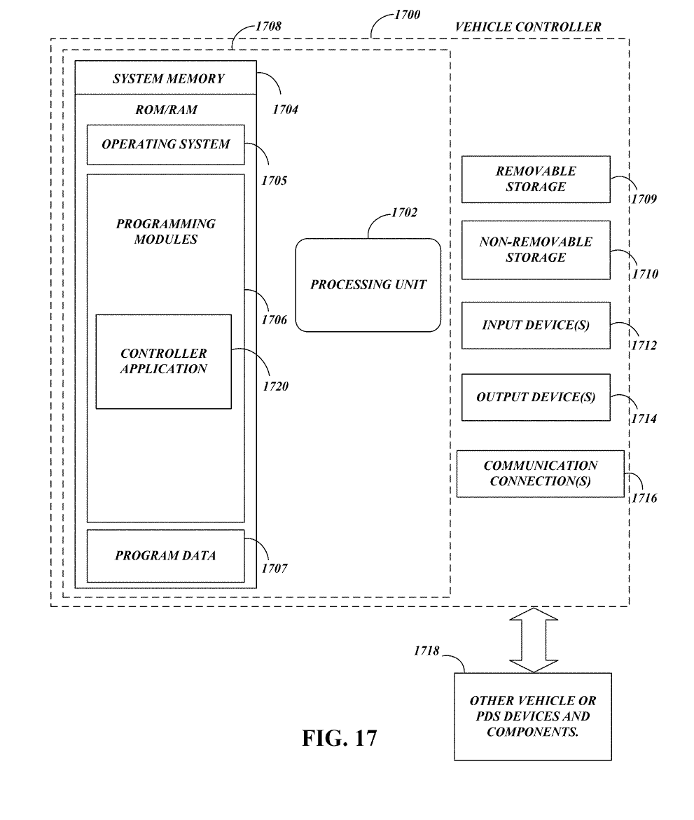

As described herein, various components of the vehicle can be in operable communication with the on-board vehicle controller 126, as further detailed with reference to FIG. 17. By way of non-limiting example, vehicle communication module 128 can both send and receive data to and from a remote location (e.g., the PDS controller or a vehicle operator). For example, vehicle communication module 128 be used to receive control signals from the PDS controller or a remotely-located operator. The control signals may be processed and decrypted by the vehicle controller 126, which, in turn, may operate the vehicle accordingly.

Furthermore, the vehicle communication module 128 can be used to communicate various data from the vehicle to, for example, a PDS controller or a remotely located operator. Data may include, but not be limited to, for example, sensor data collected by various sensors on-board the vehicle (e.g., sensors within or outside the craft 110). In yet further embodiments, the data may include telemetric data for the vehicle, including, but not limited to, for example, global positioning data, accelerometer data, gyroscopic data, velocity data, and the like. In still further embodiments, the data may be collected, processed, and encrypted by the vehicle controller prior to its communication.

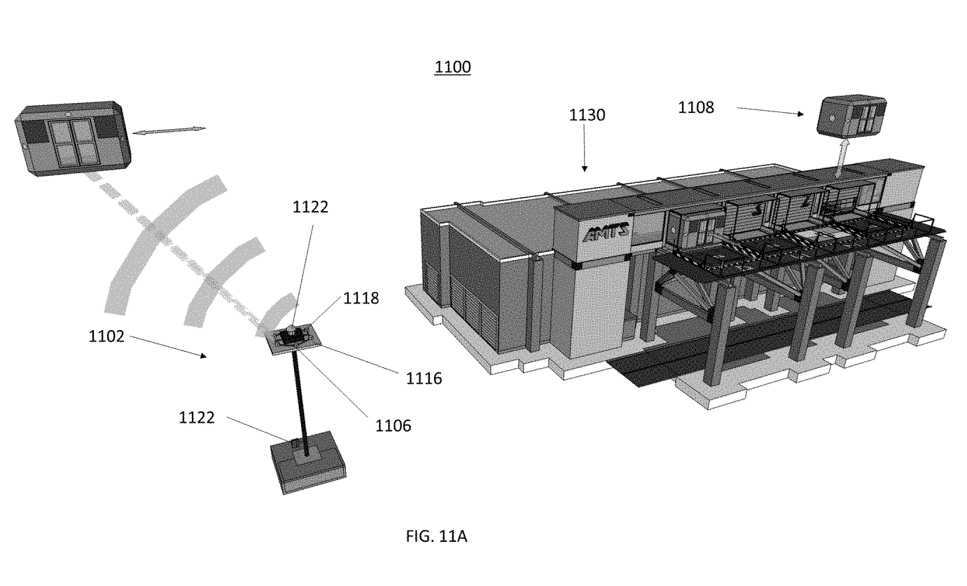

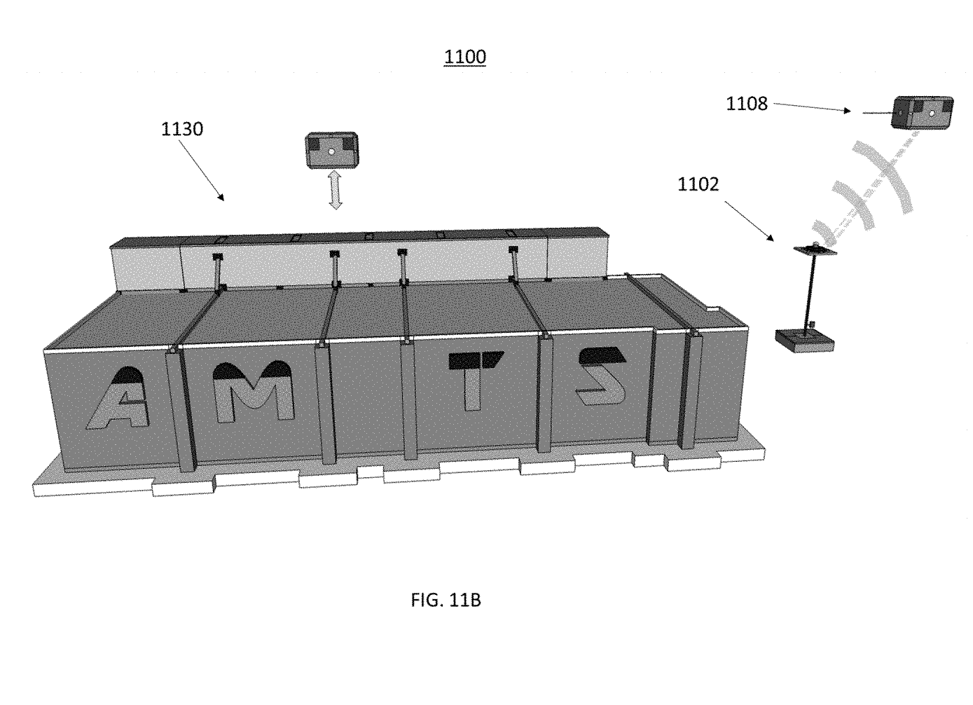

In further aspects, FIGS. 11A and 11B show another exemplary system 1100 for moving vehicles configured as an aerial mass transit system (ATMS). In this embodiment, the system comprises: a power distribution station (PDS) 1102, the power distribution station comprising: a transmitter array 1106 comprising a plurality of transmitters and coupled to a power source, each transmitter array configured to wirelessly transmit power to a receiver; and a flight-capable vehicle 1108, the vehicle configured as hybrid payload vehicle and relay vehicle, and configured to receive and utilize the power transmitted from the transmitter array to power the vehicle. As further depicted in FIGS. 11A and 11B, the power distribution station comprises an elevated platform 1116, to provide an elevated operating surface for the components of the power distribution station. Further, the present embodiment comprises a vehicle storage facility (VSF) 1130 configured to house one or more vehicles.

In further aspects, the Aerial Mass Transit System (AMTS) is a highly automated vehicle management network that can dispatch vehicles to customer locations. For example, when a vehicle is requested the AMTS sends the nearest available vehicle to the desired departure site. Further, the system monitors and adjusts corridor capacity. For example, the AMTS tracks vehicle movements along the designated routes of the network and determines when additional lanes are needed to handle increased traffic. In some aspects, when traffic loads decrease on a given route, the AMTS reduces the route's lanes to the minimum required level. Additionally, if a specific route reaches its maximum lane capacity, the AMTS may designate alternative routes for subsequent vehicles until the primary route's load decreases. The system can also maintain a preventative maintenance cycle (PMC) database. In this aspect, the AMTS keeps track of vehicle service hours and mandates a PMC at regular intervals. A PMC can consist of a vehicle system diagnostic and may either clear a vehicle for further operation, or declare a vehicle un-flightworthy and remove it from service pending repair, retrofit, or decommission.

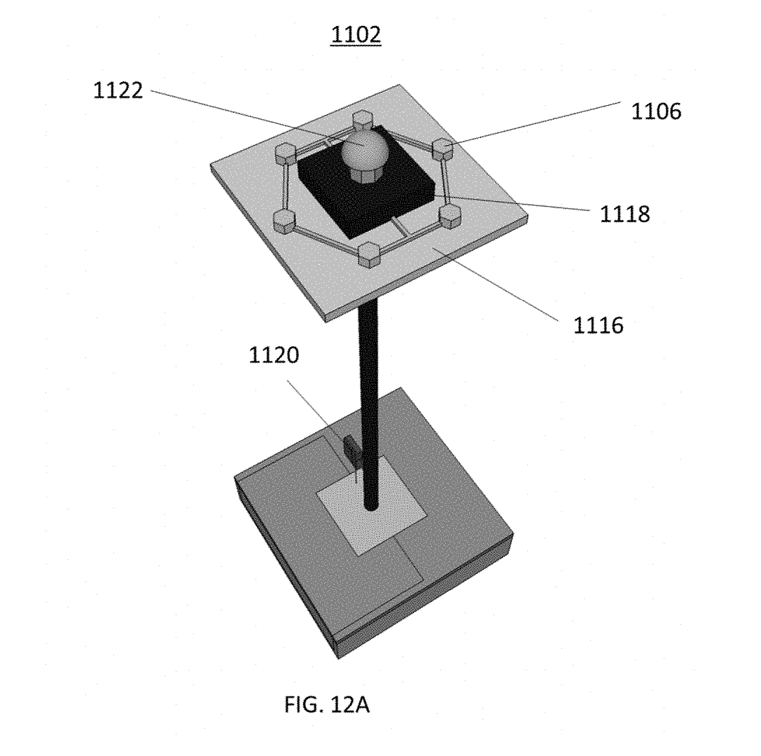

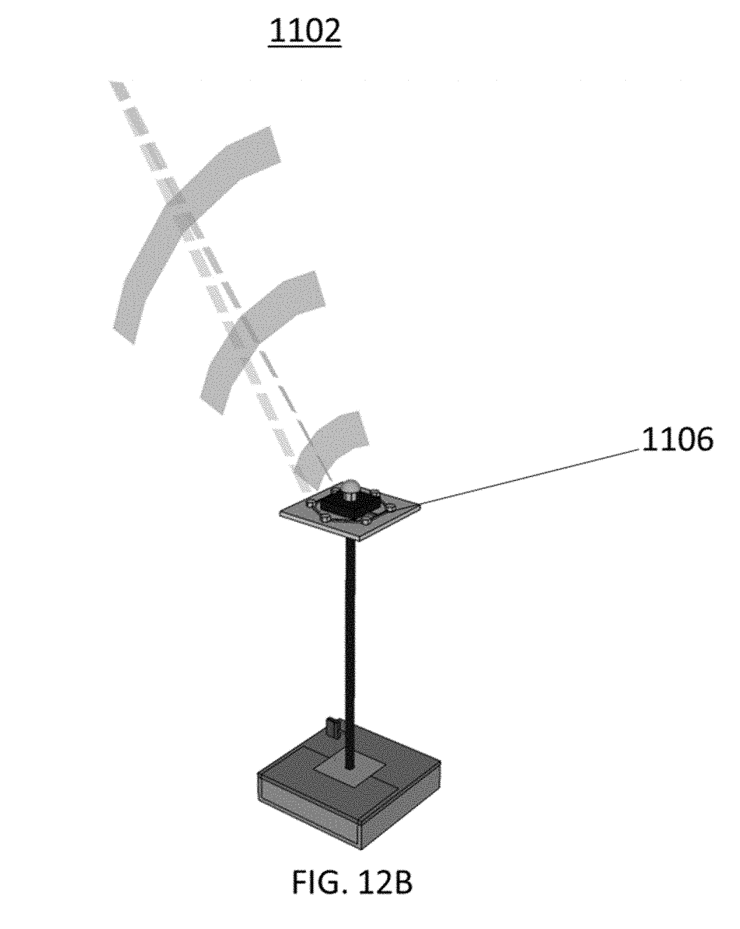

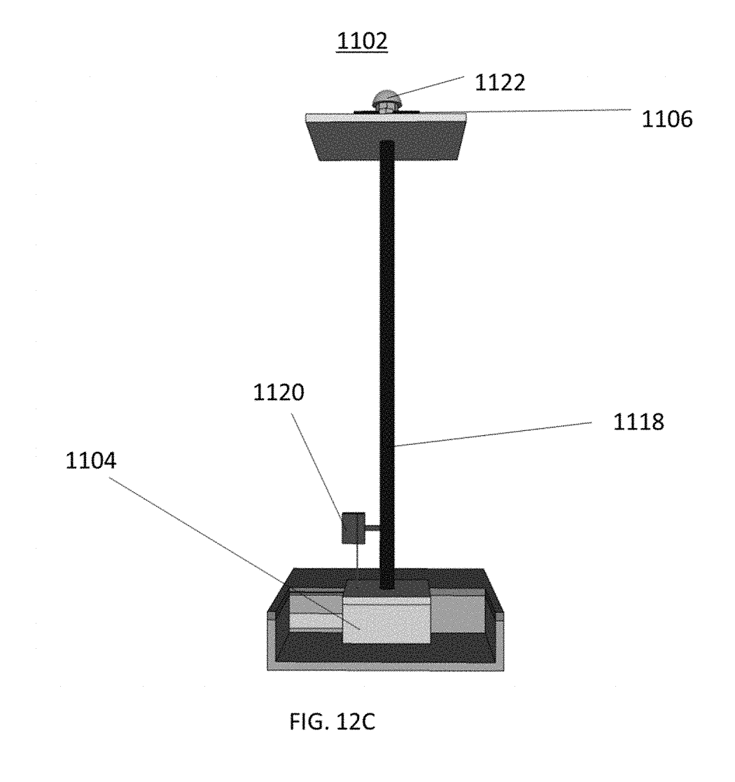

In further aspects, FIGS. 12A-12C show various view of an exemplary embodiment of a power distribution station (PDS) 1102 used in the ATMS configuration. In this embodiment, each power distribution station comprises: a power source 1104; a transmitter array 1106 comprising a plurality of transmitters, the transmitter array being configured to wirelessly transmit power to a receiver; an elevated platform 1116 comprising a structure configured to provide an operating surface for the components of the power distribution station; a power distribution station controller 1118, a communication module 1120, and a tracking module 1122. As shown in FIG. 12B, the power source 1104 and the PDS controller 1118 are coupled to the transmitter array 1106 on the elevated platform 1116 using cable and/or circuitry located in a conduit. To this end, the PDS controller and related devices are configured to monitor and control operation of the power distribution station. For example, PDS controller 1118 can be configured to track and report the location of a vehicle using one or more tracking modules 1122, convert location data into positional data for the transmitter array 1106 to control flight cycle management; communicate with any occupants of the vehicle using the communication module 1120, (e.g. radio), or the like. As shown in FIG. 12B, the PDS controller 1118 can be configured to determine if any vehicles are within the range of a transmitter array, and when a vehicle is within range, transfer power from the power source 1104 to the transmitter antenna of the transmitter array 1106 to wirelessly transmit power to the vehicle.

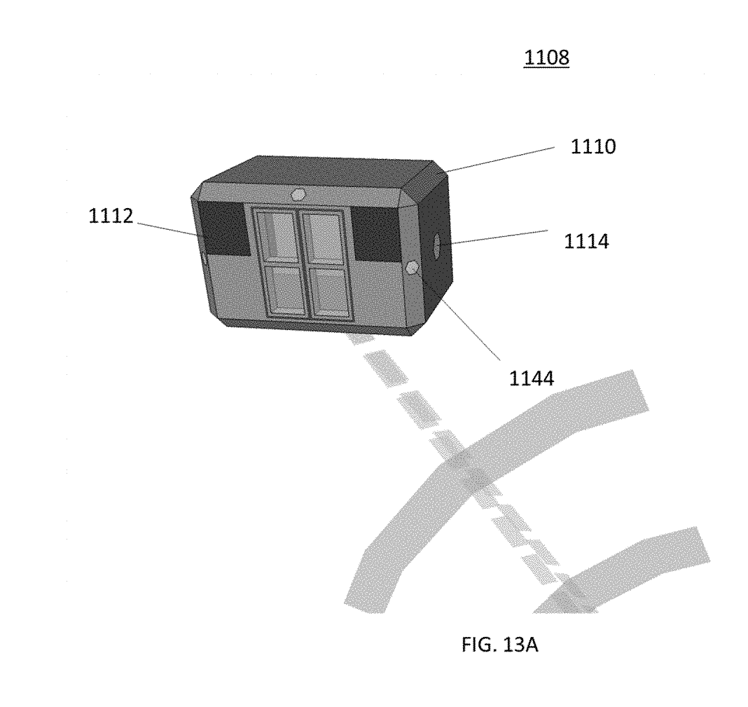

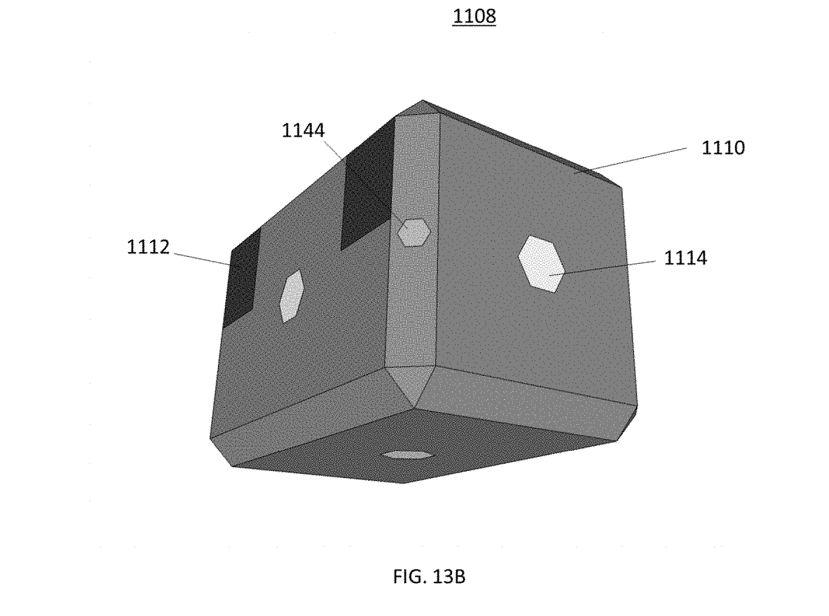

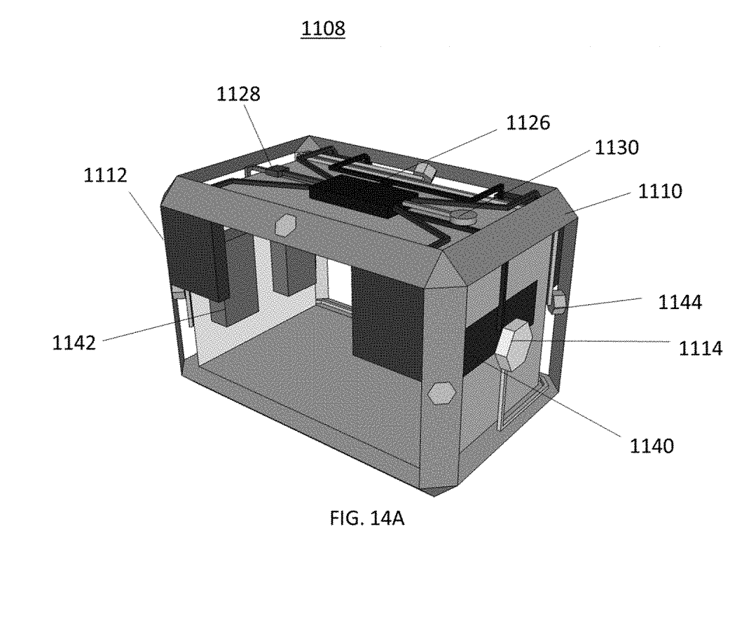

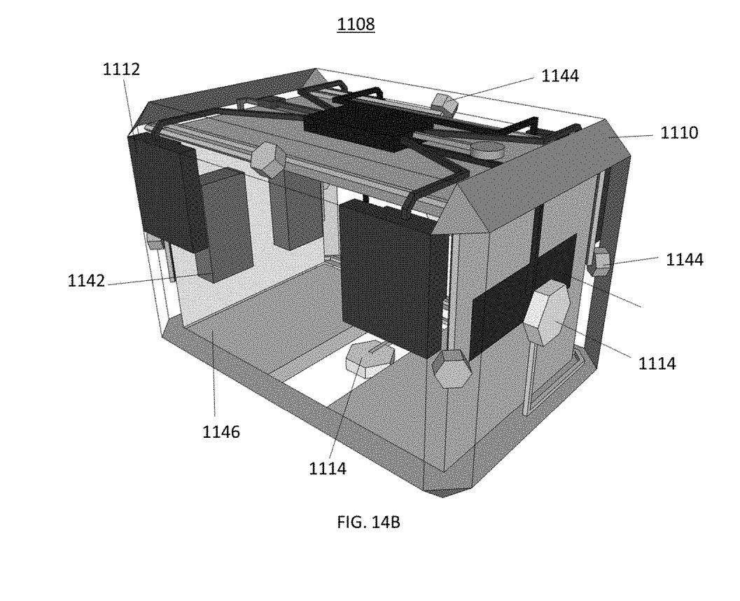

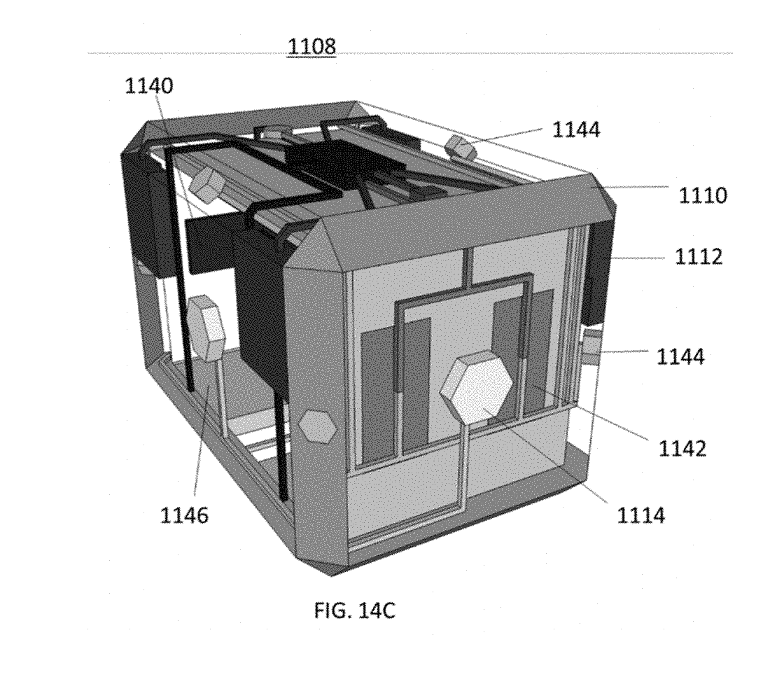

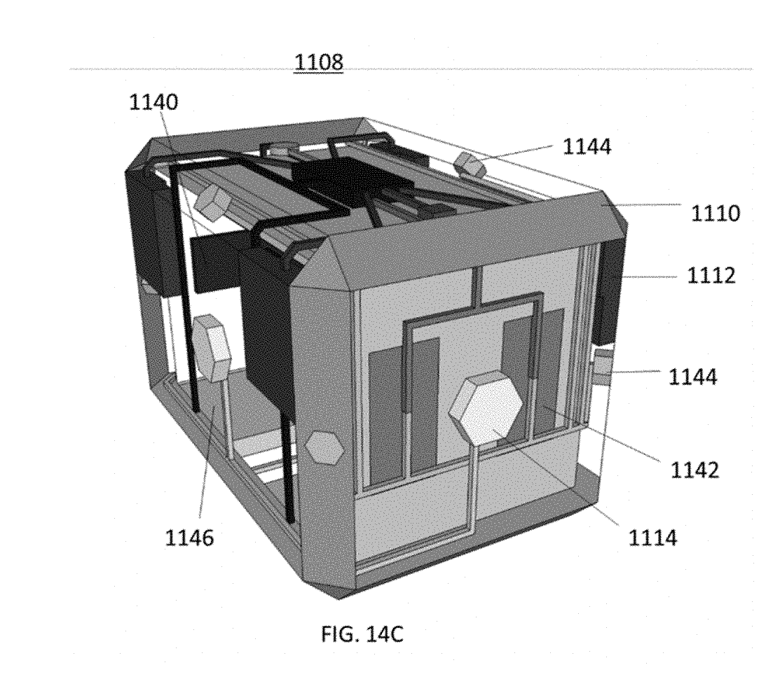

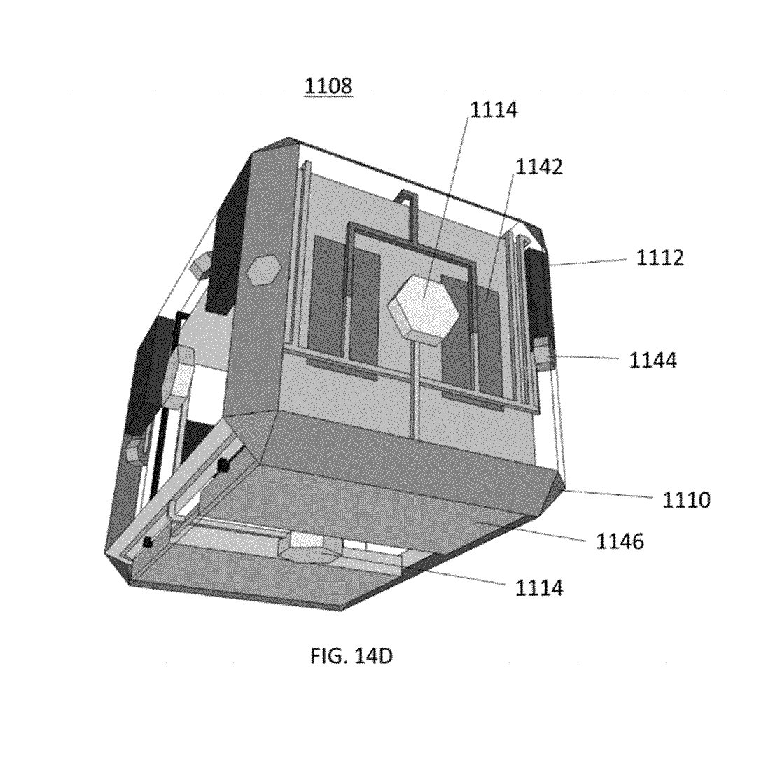

In further aspects, FIGS. 13A-14D show various views of another exemplary embodiment of a flight-capable aerial vehicle 1108. In various aspects, vehicles used in the AMTS can comprise multiple configurations. For example, the vehicle can be configured as a payload vehicle or a relay vehicle, or a hybrid payload/relay vehicle 1108 depicted in the figures. In a general aspect, payload vehicle is configured to carry passengers and or cargo, or any combination thereof, and can be configured for passenger interaction, such as with user interfaces and controls. The payload vehicle can comprise at least one of: doors, windows, interior lights, seating, information displays, cargo tie-down points, and climate control, and the like.

Relay vehicles can be configured to extend the range of payload vehicles by collecting and storing electromagnetic energy from PDSs and retransmitting the stored energy to other payload vehicles and/or relay vehicles, such as, for example, in situations where vehicles would otherwise be out of line of sight of a PDS or transmitters, and can comprise a power management unit. In still further aspect, the power management unit can comprise at least one transmitter relay comprising a plurality of transmitter, each transmitter relay configured to wirelessly transmit power to a receiver, and an energy storage component such as a battery. To this end, a relay vehicle comprising a power management unit can act as a mobile aerial version of a power distribution station, complete with tracking, control, and communication abilities plus a transmitter array that all function similarly to their ground-based variants. The power management unit can comprise equipment to move power from the receiver to the power management unit for distribution to other vehicles while maintaining power to the relay vehicle's components.

The hybrid vehicle 1108 comprise components and elements of both a payload vehicle and a relay vehicle, and is configured to carry a payload and to receive, utilize, and transmit power transmitted from the PDS transmitter array. As further depicted in FIGS. 14A-14D, the vehicle 1108 comprises a craft 1110 configured to carry a payload; at least one receiver 1114 configured to receive and utilize the power transmitted from the transmitter array to power the vehicle; a lifting array 1112 comprising a plurality of ion-producing propulsion means; a vehicle controller 1126, a vehicle communication module 1128, and a vehicle tracking module 1130. The vehicle further comprises a user interface unit 1140, a power management unit 1142, multiple transmitter relays 1144, and an energy storage component 1146.

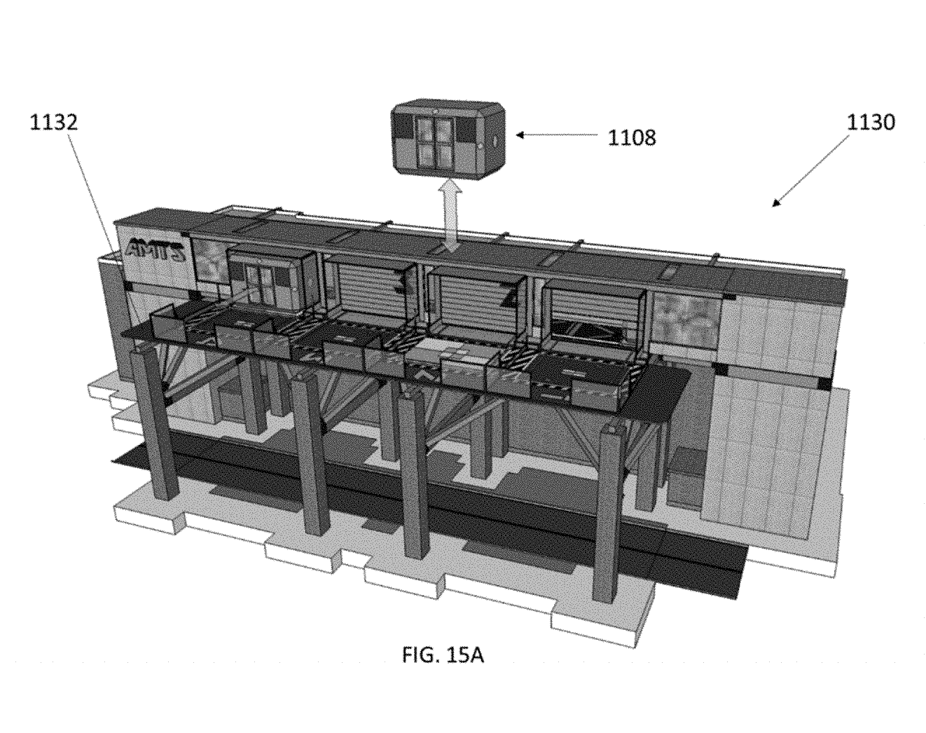

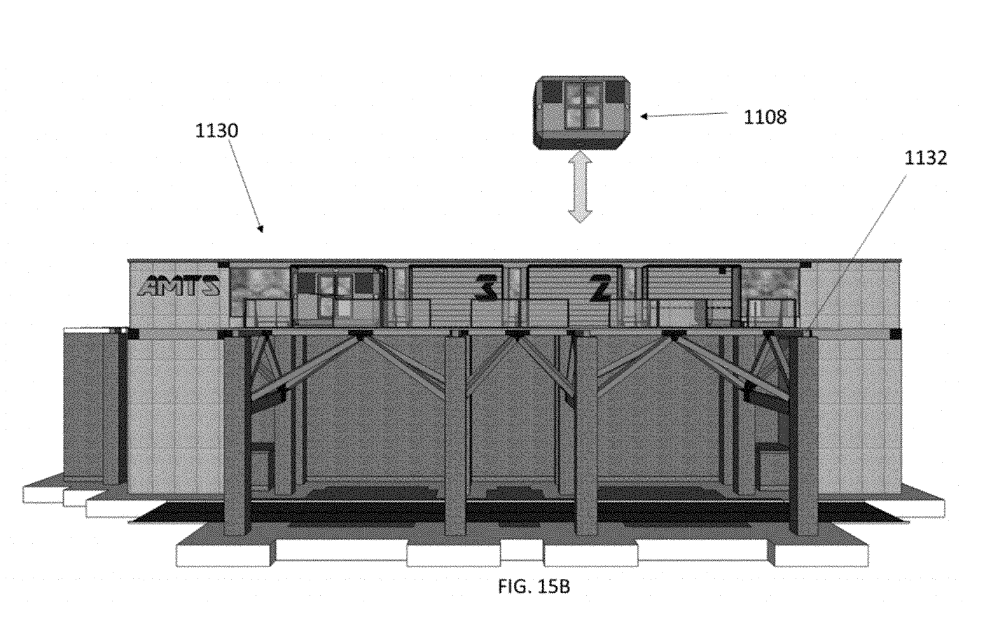

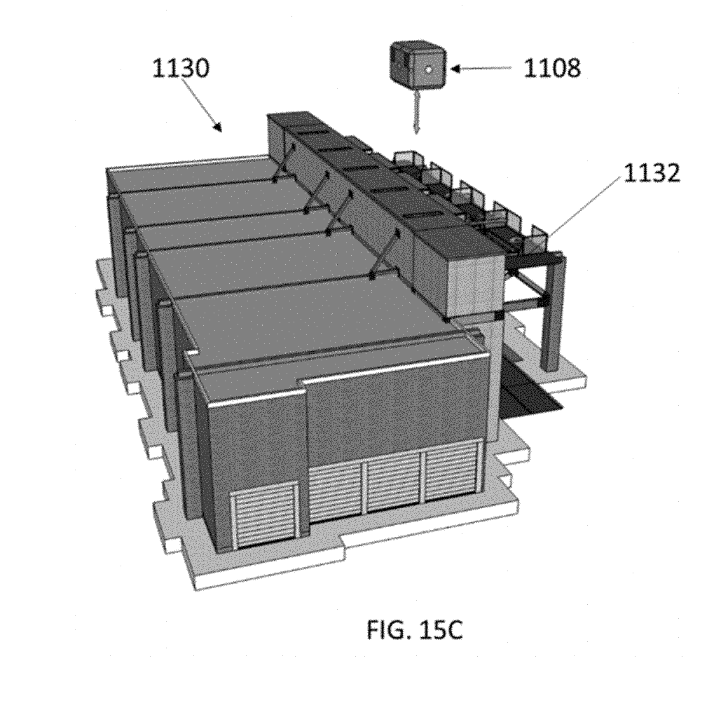

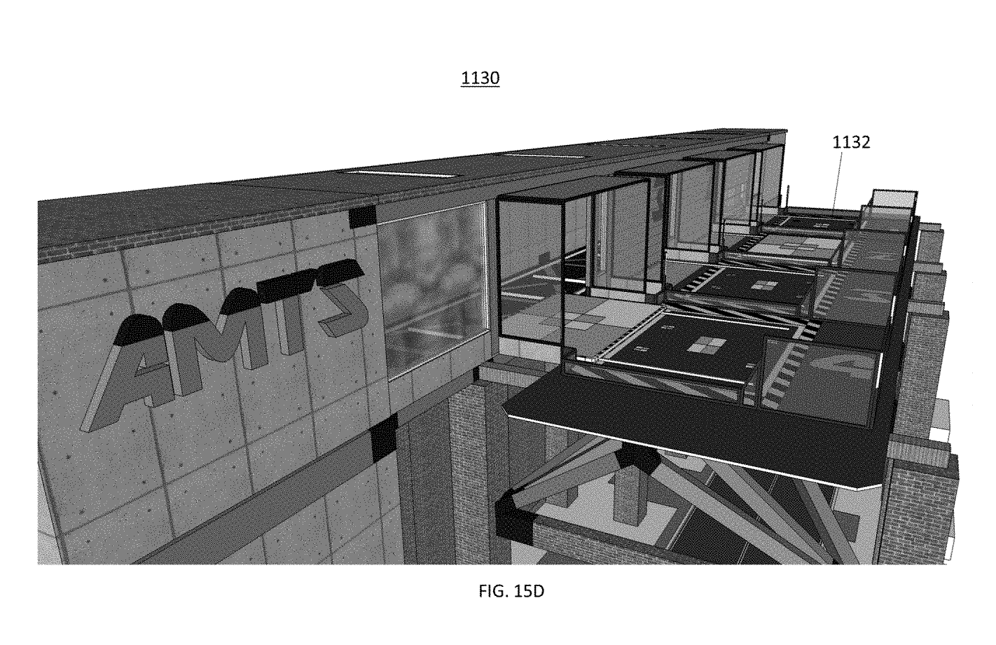

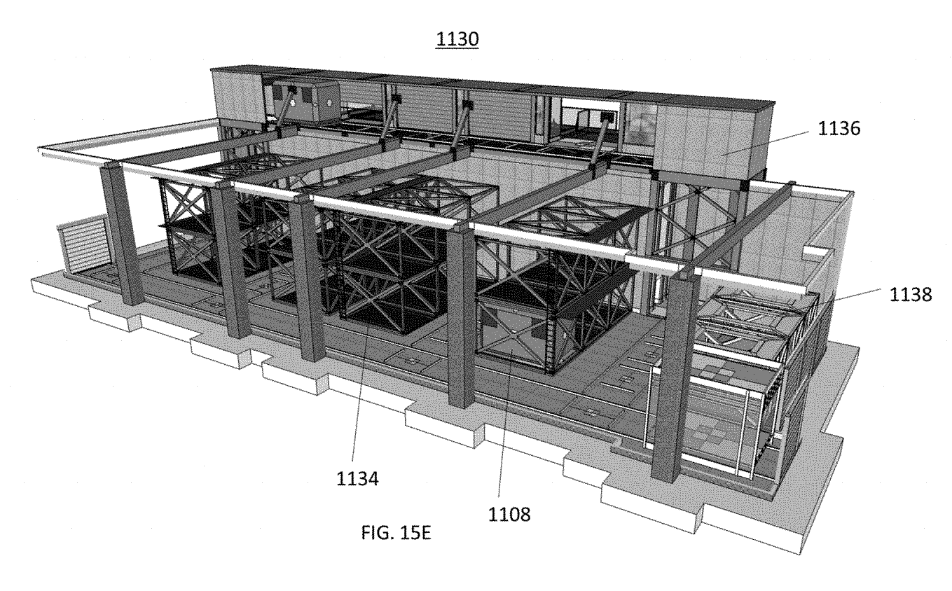

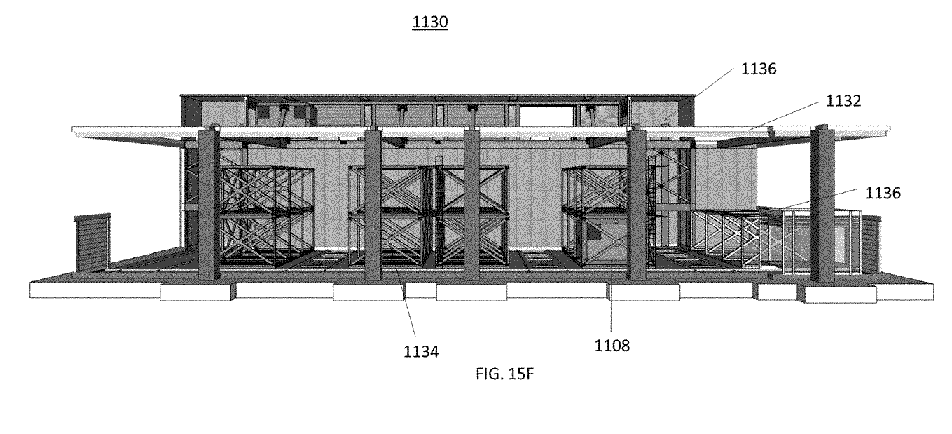

In further aspects, FIGS. 15A-F show various view of an exemplary embodiment of a vehicle storage facility (VSF) 1130 arranged as a commercial VSF with elevated landing and take-off platform 1132. In the present ATMS embodiment. the VSF comprise automated, climate-controlled hangars with moving platforms that taxi vehicles into and out of a warehouse containing holding bays (bay) 1134. In some aspects, once a vehicle is not needed, the vehicle can navigate to a VSF landing/take-off platform. In further aspects, the vehicle may be secured to the platform and moved into the warehouse where a conveyance system 1136 moves it to an available bay 1134. In still further aspects, the vehicle may be left in the bay while the disengaged platform moves to: collect a requested vehicle from a different bay, receive another arriving vehicle, or wait in a platform holding silo in the warehouse. In yet some aspects, the VSF can comprise a landing and/or take-off area with several platform spaces to facilitate multiple vehicles arriving and/or departing simultaneously.

In various aspects, the VSF can be configured to handle unoccupied arriving vehicles and functioning as described herein with an on-demand schedule. In further aspects the VSFs can serve as storage hubs during off-peak hours. The VSFs can comprise added pedestrian amenities (walkways, seating areas, loading docks, etc.) to accommodate occupied vehicles arriving and departing from the VSF. In further aspects, VSFs of various capacities can serve as short-term holding sites for vehicles that may be needed again shortly, and may be needed to absorb high demand spikes associated with densely populated locations.

In some embodiments, the AMTS keeps track of vehicle service hours and mandates a preventative maintenance cycle (PMC) at regular intervals. Thus, the PMC may either clear a vehicle for further operation, or declare a vehicle un-flightworthy. In this embodiment, the vehicle could be sent to the VSF repair bay 1138 for service.

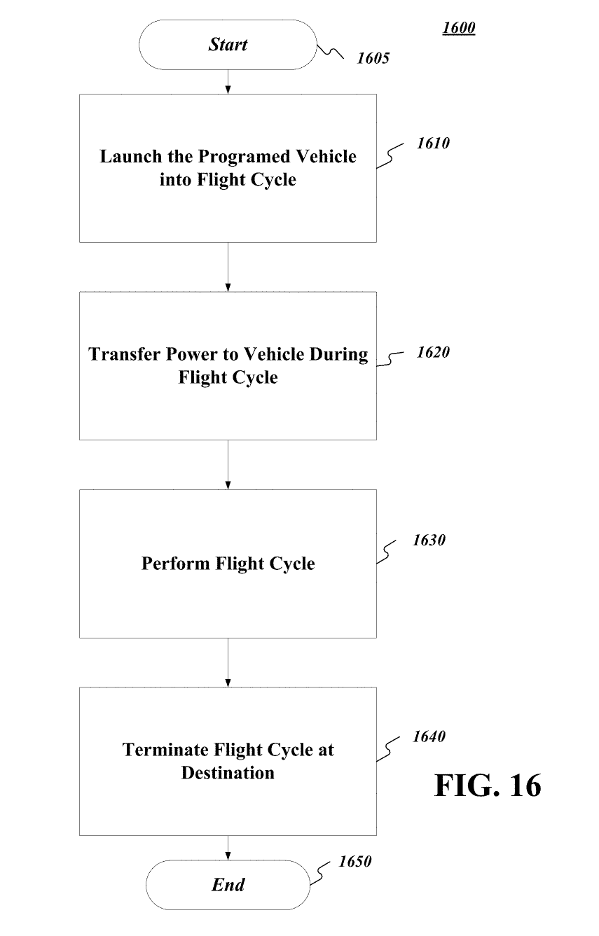

In further aspects, FIG. 16 shows a flow chart setting forth the general stages involved in a method 1600 in accordance with an exemplary embodiment of the disclosure for operating the aerial vehicle and system. Method 1600 can be implemented using, at least in part, a controller 1700 (e.g., on board computing device) as described in more detail below with respect to FIG. 17. Controller 1700 can comprise a controller for operating the vehicle and or system components as well as well as performing other flight cycle details, including, but not limited to, flight control, payload operation, and communication. As such, controller 1700 may be in operative configuration and communication with system components, for example, but not be limited to, a vehicle communication module 128, a vehicle tracking module 130, receiver 114, the lifting array 112, global positioning system, various sensors, and PDS controller 118, as well as all other system units and equipment. As will be detailed with reference to FIG. 17, controller 1700 can comprise a communication module 128 to enable remotely operation as described above. In other embodiments, controller 1700 may be completely self-operating upon configuration. In this way, the vehicle can be self-piloting.

In further aspects, although stages are disclosed with reference to controller 1700, it should be understood that a plurality of other components may enable the operation of method 1600, including, but not limited to, other computing components, mechanical components, environment properties (e.g., air resistance), remote operators, local operators, and the like.

In still further aspects, although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein.

Method 1600 may begin at starting block 1605 and proceed to stage 1610, where the vehicle may be launched. For example, the vehicle may be launched from a launching pad or dropped from a carrier aerial vehicle. Prior to launch, the combined weight of the vehicle and its payload may be determined and the total energy required to propel the vehicle through the flight cycle to its destination may be calculated. In some aspects, the power source may charge one or more battery coupled to the PDS power source. The loaded vehicle can be launched by wirelessly transferring the power through the transmitter array to the vehicle receiver, either directly from the power source or using energy stored in a battery.

From stage 1610, where the vehicle is launched, method 1600 may proceed to stage 1620 where the vehicle flight components may be deployed. The deployment of vehicle flight components, though disclosed in a particular order for illustrative purposes, may occur in other arrangements. In one aspect, the power is transferred from its receiver to its lifting array causing the vehicle to take flight.

From stage 1620, where the vehicle flight components are deployed and vehicle flight is stabilized, method 1600 may proceed to stage 1630, where the vehicle may proceed to complete a flight cycle or proceed to a destination. During all stages of flight, the vehicle may be in operable communication with a remote operator or with the PDS controller. The remote operator or controller may receive various readings from the various components of the vehicle. In some embodiments, the remote operator or controller may control the operation of the vehicle during the flight cycle. For example, the remote operator or controller may be able to control the vehicle flight components, including, but not limited to, vehicle controller 126, vehicle communication module 128, vehicle tracking module 130, receiver 114, the lifting array 112, global positioning system, various sensors, and the like. In some aspects, on-board controller 1700 may be pre-configured with flight control data. In further aspects, the vehicle can continue to accelerate until it leaves the atmosphere or moves beyond the range of the transmitter array. In other aspects, the vehicle can use forward momentum and a pre-planned course to coast to its destination.

From stage 1630, where the vehicle is used to perform a flight cycle or mission, method 1600 may proceed to stage 1640, where the flight cycle is terminated. For example, the flight cycle may be terminated by flying the vehicle to its destination, or to a recovery location where it may be recovered. Further, the flight cycle may terminate a flight cycle by returning to the location of its launch or another PDS site. In some aspects, the vehicle may return to a PDS or base station from its high altitude destination intact using a method in which power to the transmitters is gradually reduced after the vehicle is positioned over the transmitter array. This allows the vehicle to be lowered onto a designated landing area and reused. After stage 1640, method 1600 may end at stage 1650. The method may be repeated as quickly as a vehicle can be prepped for take-off and the power source or battery is ready to provide power.

In further aspects, the vehicle and or PDS may comprise, but not be limited to, an on-board computing module or device. The computing module or device may be in operative configuration and communication with, for example, vehicle controller 126, vehicle communication module 128, vehicle tracking module 130, receiver 114, the lifting array 112, global positioning system, various sensors, power distribution station controller 118, PDS communication module 120, PDS tracking module 122, the power source 104, and the transmitter array 106. Further, the computing device may be in operative communication with another computing device consistent with the description herein, and may comprise, but not be limited to, a desktop computer, laptop, a tablet, or mobile telecommunications device. Such remote devices may be used to control and/or configure on-board computing module (e.g., deployment conditions, mission controls, and the like). Moreover, the vehicle or PDS may be in operative communication with a centralized server, such as, for example, a cloud computing service. Although operation has been described to be performed, in part, by a controller 1700, it should be understood that, in some embodiments, different operations may be performed by different networked elements in operative communication with controller 1700. Embodiments of the present disclosure may comprise a system having a memory storage and a processing unit. The processing unit may be coupled to the memory storage, wherein the processing unit is configured to perform the stages of method 1600.

FIG. 17 is a block diagram of a system including controller 1700. In accordance with an exemplary embodiment of the disclosure, the aforementioned memory storage and processing unit maybe implemented in a computing device, such as controller 1700 of FIG. 17. Any suitable combination of hardware, software, or firmware may be used to implement the memory storage and processing unit. For example, the memory storage and processing unit may be implemented with controller 1700 or any of other PDS or vehicle devices and components 1718, in combination with controller 1700.

The aforementioned system, device, and processors are examples and other systems, devices, and processors may comprise the aforementioned memory storage and processing unit, consistent with embodiments of the disclosure.

With reference to FIG. 17, a system consistent with an embodiment of the disclosure may include a computing device, such 5 as controller 1700. In a basic configuration, controller 1700 may include at least one processing unit 1702 and a system memory 1704. Depending on the configuration and type of computing device, system memory 1704 may comprise, but is not limited to, volatile (e.g. random access memory (RAM)), non-volatile (e.g. read-only memory (ROM)), flash memory, or any combination. System memory 1704 may include operating system 1705, one or more programming modules 1706, and may include a program data 1707. Operating system 1705, for example, may be suitable for controlling controller 1700's operation. In one embodiment, programming modules 1706 may include flight control application 1720. Furthermore, embodiments of the disclosure may be practiced in conjunction with a graphics library, other operating systems, or any other application program and is not limited to any particular application or system. This basic configuration is illustrated in FIG. 17 by those components within a dashed line 1708. Controller 1700 may have additional features or functionality. For example, controller 1700 may also include additional data storage devices (removable and/or nonremovable) such as, for example, magnetic disks, optical disks, or tape. Such additional storage is illustrated in FIG. 17 by a removable storage 1709 and a non-removable storage 1710. Computer storage media may include volatile and nonvolatile, removable and nonremovable media implemented in any method or technology for storage of information, such as computer readable instructions, data structures, program modules, or other data. System memory 1704, removable storage 1709, and non-removable storage 1710 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, 5 magnetic disk storage or other magnetic storage devices, or any other medium which can be used to store information and which can be accessed by controller 1700. Any such computer storage media may be part of device 1700. Controller 1700 may also be operative with input device(s) 1712 such as a keyboard, a mouse, a pen, a sound input device, a touch input device, etc. Input device(s) 1712 may be used to, for example, manually access and program controller 1700. Output device(s) 1714 such as a display, speakers, a printer, etc. may also be included. The aforementioned devices are examples and others may be used.

Controller 1700 may also contain a communication connection 1716 that may allow device 1700 to communicate with other PDS or vehicle devices and components 1718 (e.g., communication module), such as over an encrypted network in a distributed computing environment. Communication connection 1716 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media. As stated above, a number of program modules and data files may be stored in system memory 1704, including operating system 1705. While executing on processing unit 1702, programming modules 1706 (e.g., controller application 1720) may perform processes including, for example, one or more of stages or portions of stages of method 1600 as described above. Controller application 1720 may be configured to operate system or vehicle devices and components 1718 and receive instructions from, for example, communications connections module 1716. The aforementioned process is an example, and processing unit 1702 may perform other processes.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems. Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein can be different from the actual publication dates, which can require independent confirmation.

The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed:

1. A system for moving vehicles, the system comprising:
at least one power distribution station (PDS), each power distribution station comprising:
a power source;
at least one transmitter array comprising a plurality of transmitter, each transmitter array configured to wirelessly transmit power to a receiver; and
at least one flight-capable vehicle, each vehicle comprising:
a craft configured to carry a payload;
at least one receiver configured to receive and utilize the power transmitted from the transmitter array to power the vehicle; and
a lifting array comprising a plurality of ion-producing propulsion means, the lifting array coupled to the vehicle and configured to lift the vehicle to a predetermined altitude and distance using power from the receiver.

2. The system of claim 1, the at least one power distribution station further comprising at least one energy storage unit.

3. The system of claim 1, wherein the transmitters are positioned at predetermined distance intervals to provide different lines of sight to the vehicle.

4. The system of claim 1, wherein a first transmitter array is positioned beneath a launch platform to power the vehicle during an initial portion of flight, and second transmitter array is located away from the first transmitter array and powers the vehicle once the vehicle moves beyond the range of the first transmitter array.

5. The system of claim 1, wherein the at least one power distribution station further comprises a power distribution station controller configured to monitor and control operation of the power distribution station.

6. The system of claim 5, wherein the power distribution station PDS controller further comprises a monitoring module, or a communication module, or a tracking module, or any combination thereof.

7. The system of claim 5, wherein the PDS controller is configured to determine if any vehicles are within the range of a transmitter array, and wherein when a vehicle is within range, transfer power from the power source to the transmitter array to wirelessly transmit to the vehicle.

8. The system of claim 5, wherein the PDS controller is configured to utilize positional data to direct to orient the transmitter array towards a designated vehicle.

9. The system of claim 1, wherein the lifting array is configured to produce lift using electrohydrodynamic phenomena associated with high voltages applied to fluids.

10. The system of claim 1, wherein the vehicle comprises a vehicle controller to monitor and control operation of the vehicle.

11. The system of claim 8, wherein the vehicle controller is configured to dynamically supply differing voltages to the various ion-producing devices to orient the vehicle.

12. The system of claim 8, wherein the vehicle controller comprises a protocol that determines if a vehicle or vehicle operator has clearance to operate or send a vehicle to a selected destination.

13. The system of claim 1, wherein the vehicle further comprises at least one energy storage unit configured to store a required energy for at least one complete flight cycle.

14. The system of claim 1, wherein the vehicle is configured to extend the range of other vehicles by collecting and storing electromagnetic energy from the power distribution station and retransmitting the stored energy to other vehicles that would otherwise be out of line of sight of a transmitter array or power distribution station.

15. The system of claim 12, wherein the vehicle further comprises a power management unit, the power management unit comprising at least one transmitter relay comprising a plurality of transmitters, each transmitter relay configured to wirelessly retransmit power to a receiver of another vehicle.

16. The system of claim 1, further comprising at least one support structure.

17. The system of claim 14, wherein the at least one support structure is selected from a hangar, warehouse, assembly buildings, assembly bays, launch platforms, offices, security facilities, passenger terminals, base stations, receiver stations, or vehicle storage facility (VSF), vehicle service facility, and any combination thereof.

18. An aerial mass transit system for moving vehicles, the system comprising:
at least one power distribution station (PDS), each power distribution station comprising:
a power source;
at least one transmitter array comprising a plurality of transmitters, each transmitter array configured to wirelessly transmit power to a receiver; and
a first flight-capable vehicle, each first vehicle comprising:
a craft configured to carry a payload;
at least one receiver configured to receive and utilize the power transmitted from the transmitter array to power the vehicle; and
a lifting array comprising a plurality of ion-producing propulsion means, the lifting array coupled to the vehicle and configured to lift the vehicle to a predetermined altitude and distance using power from the receiver;
a second flight-capable vehicle, each second vehicle comprising:
a craft configured to carry a payload;
at least one receiver configured to receive and utilize the power transmitted from the transmitter array to power the vehicle;
a lifting array comprising a plurality of ion-producing propulsion means, the lifting array coupled to the vehicle and configured to lift the vehicle to a predetermined altitude and distance using power from the receiver;
at least one energy storage unit configured to store a required energy amount; and
a power management unit, the power management unit comprising at least one transmitter relay comprising a plurality of transmitters, each transmitter relay configured to wirelessly retransmit power to a receiver of another vehicle; and
at least one vehicle storage facility (VSF) configured to house one or more vehicles.

19. The system of claim 17, wherein the system is configured to dispatches vehicles to a customer location upon request.

20. The system of claim 17, wherein the system is configured to track vehicle movement along designated travel routes of a network and determines when additional travel lanes are needed to handle increased traffic.
